(19) United States
(12) Patent Application Publication
(10) Pub. No.: US 2020/0108743 A1
(43) Pub. Date: Apr. 9, 2020

(54) TEMPERATURE CONTROLLED CAR SEAT STROLLER APPARATUS

(71) Applicant: Terrance Johnson, Covington, GA (US)

(72) Inventor: Terrance Johnson, Covington, GA (US)

(21) Appl. No.: 16/152,371

(22) Filed: Oct. 4, 2018

(51) Int. Cl. B60N 2/28; A47D 15/00; B60N 2/56

(52) U.S. Cl. CPC B60N 2/2848; B60N 2/2845; A47C 31/008; B60N 2/56; A47D 15/00

(57) ABSTRACT

A temperature controlled car seat stroller apparatus including a car seat and a stroller frame. The car seat includes a handle; a car seat frame including an interior cushion coupled thereto and one or more latching mechanisms; a first cooling and heating member integrated into a back rest region of the interior cushion; a second cooling and heating member integrated into a rear seat region of the interior cushion; a first massage member integrated into back rest region of the interior cushion; a second massage member integrated into the rear seat region of the interior cushion; and one or more speakers integrated into the bottom region of the car seat frame. The car seat frame is configured to couple to an interior seat of a vehicle and to a stroller frame. The stroller frame includes a handle, a plurality of wheels attached to the bottom of the stroller frame and one or more mating latching mechanisms for attachably coupling to the one or more latching mechanisms of the car seat frame.

### FIELD OF THE INVENTION

Embodiments described herein generally relate to a child car seat and stroller, and more particularly to a temperature controlled car seat stroller.

### BACKGROUND OF THE INVENTION

Strollers and car seats are top purchases for new parents. The quality in smoothness, safety, and important features can make a significant difference in complying with the parents' and child's needs. Important features such as comfort, multifunctionality and flexibility can be major distinguishing features which establish a competitive advantage for companies that sell child car seats and strollers. Thus, it is desirable to provide a car seat and stroller that provides safety features along with comfort, multifunctionality and flexibility.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary illustration of a temperature controlled car seat stroller apparatus according to an embodiment of the present disclosure.

FIG. 2 shows another exemplary illustration of a temperature controlled car seat stroller apparatus according to an embodiment of the present disclosure.

### SUMMARY OF THE INVENTION

Exemplary embodiments disclosed herein describe a temperature controlled car seat stroller apparatus. The apparatus has a car seat and a stroller frame. The car seat includes a handle; a car seat frame including an interior cushion coupled thereto and having one or more latching mechanisms; a first cooling and heating member integrated into a back rest region of the interior cushion; and a second cooling and heating member integrated into a rear seat region of the interior cushion. The car seat frame is configured to couple to an interior seat of a vehicle and to a stroller frame. The stroller frame includes one or more mating latching mechanisms for attachably coupling to the one or more latching mechanisms of the car seat frame, a handle and a plurality of wheels attached to the bottom of the stroller frame.

In some exemplary embodiments, the car seat includes a first massage member integrated into the back rest region of the interior cushion and a second massage member integrated into the rear seat region of the interior cushion.

In some exemplary embodiments, the car seat includes one or more speakers integrated into a bottom region of the car sear frame.

In some exemplary embodiments, the first and second cooling and heating members are controlled by a remote control.

In some exemplary embodiments, the first and second cooling and heating members are controlled by a smart phone.

In some exemplary embodiments, the first and second massage members are controlled by a remote control.

In some exemplary embodiments, the first and second massage members are controlled by a smart phone.

In some exemplary embodiments, the one or more speakers are Bluetooth speakers.

In some exemplary embodiments, the first and second cooling and heating members are operable in one or more user-controlled operating settings.

In some exemplary embodiments, the first and second massage members are operable in one or more user-controlled operating settings.

Another exemplary embodiment disclosed herein describes a temperature controlled configurable car seat apparatus having a car seat that includes a handle, a car seat frame including an interior cushion coupled thereto, a first cooling and heating member integrated into a back rest region of the interior cushion, a second cooling and heating member integrated into a rear seat region of the interior cushion, a first massage member integrated into the back rest region of the interior cushion and a second massage member integrated into the rear seat region of the interior cushion, and one or more speakers integrated into a bottom region of the car seat frame. The first and second cooling and heating members and the first and second massage members are each operable in one or more operating settings.

In some exemplary embodiments, the car seat frame includes one or more latching mechanisms for attachably coupling to a stroller frame.

In some exemplary embodiments, the one or more speakers are Bluetooth speakers.

In some exemplary embodiments, the operating settings of the first and second cooling and heating members are controllable by a remote control.

In some exemplary embodiments, the operating settings of the first and second cooling and heating members are controllable by a smart phone.

In some exemplary embodiments, the operating settings of the first and second massage members are controllable by a remote control.

In some exemplary embodiments, the operating settings of the first and second massage members are controllable by a smart phone.

### DETAILED DESCRIPTION

The present disclosure relates to a temperature controlled car seat stroller apparatus. The apparatus includes a car seat member that is configured to couple to an interior seat of a vehicle and to a stroller frame member. The apparatus can be configured as a car seat and the apparatus can be configured as a stroller. The car seat includes a built in cooling/heating system. The car seat may also include a built in massage system and built in speakers. The built-in cooling/heating system and massage system may be controlled using a remote control or a smart phone. The built in speakers may stream music from a smart phone.

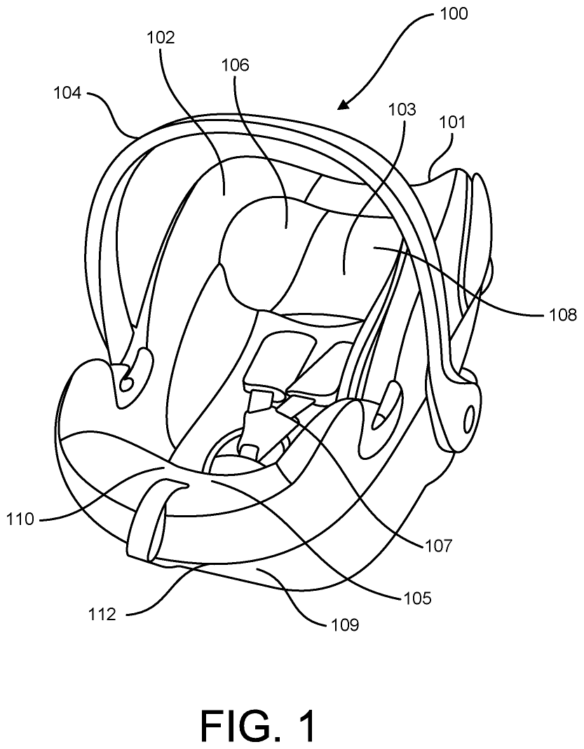

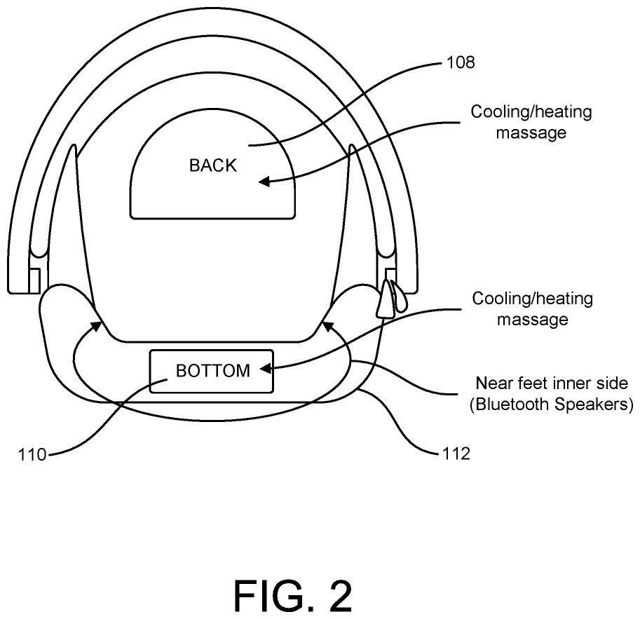

As illustrated in FIGS. 1-2, the temperature controlled car seat stroller apparatus 100 includes a car seat member 101 and a stroller frame member (not shown). The car seat member includes an arm rest/handle 104, a car seat frame 102, an interior cushion 106, a first cooling and heating member 108, a second cooling and heating member 110, a Y-shaped harness 107 and one or more latching mechanisms (not shown). The stroller frame member includes one or more mating latching mechanisms for attachably coupling to the one or more latching mechanisms of the car seat frame, a handle and a plurality of wheels attached to the bottom of the stroller frame member. The stroller frame member is configured to receive the car seat member for attachment when the apparatus is configured to operate as a stroller.

The arm rest/handle 104 is attached to the car seat frame 102 and can be positioned up and down. The arm rest/handle can be used as an arm rest or as a handle depending on the positioning of the arm rest/handle. The frame 102 of the car seat member 101 is shaped and sized to seat a baby/toddler/child occupant. The frame includes a seated area having a head rest region, back rest region and a rear seat region. The frame is rigid and can be made of any suitable material. In a preferred embodiment, the frame is made of polypropylene and is made by an injection mold process. The frame includes a cover and an interior cushion 106 secured thereto.

The interior cushion 106 lines the seated area of the frame including head rest region, back rest region 103 and rear seat region 105. The interior cushion can be made of any suitable materials. In a preferred embodiment, the interior cushion is made fabric and foam padding. The interior cushion has a built in first cooling and heating member 108 located in the back rest region 103 and a second cooling and heating member 110 located in the rear seat region 105.

The first cooling and heating member 108 and the second cooling and heating member 110 each include a cooling element for cooling the back rest region and the rear seat region respectively, and each include a heating element for heating the back rest region and the rear seat region respectively. Any suitable mechanism may be used for the cooling element and the heating element, such as, for example, a plurality of thermoelectric elements, where each thermoelectric element is individually controllable to be one of a heating element or a cooling element.

The first cooling and heating member 108 and the second cooling and heating member 110 may be controlled by a remote control. In another exemplary embodiment, the first and second cooling and heating members may be controlled by a smart phone. The cooling and heating members may be controlled to adjust the temperature/operating settings. A user may control the cooling and heating members to operate in one or more user-controlled operating settings, such as, for example, at a particular temperature, within an approximate temperature range, or at a particular temperature level (e.g., warm, warmer, etc.).

In an exemplary embodiment, the temperature controlled car seat stroller apparatus includes a sensor for detecting the temperature of the first and second cooling and heating members. The cooling and heating members may be controlled to shut down if the temperature is too high, too low or falls outside a desired temperature range.

The Y-shaped harness 107 slips over the occupant's head and both shoulders and fastened between the occupant's legs. The Y-shaped harness operates as a safety belt/child restraint mechanism.

The one or more latching mechanisms attachably connect the car seat member and the stroller frame member. The one or more latching mechanisms may be any suitable mechanism. In a preferred embodiment the one or more latching mechanisms are snap on fittings. The one or more mating latching mechanisms are fittings configured to receive the car seat latching mechanisms.

In another exemplary embodiment, the first and second cooling and heating members each also include a massage member. In an alternative embodiment, the car seat member 101 includes first and second massage members, separate from the first and second cooling and heating systems, located in the back rest region of the interior cushion 103 and the rear seat region of the interior cushion 105 respectively.

The first and second massage members may be made of any suitable mechanism, such as, for example, an electromechanical vibrating device. When activated, the vibrating device introduces vibrational waves into the back rest region and the rear seat region of the car seat frame. The vibrational waves causes vibration in the back rest region and the rear seat region in a massaging or soothing fashion.

The first and second massage members may be controlled by a remote control. In another exemplary embodiment, the first and second massage members may be controlled by a smart phone. The massage members may be controlled to operate in one or more user-controlled operating settings, such as, for example, massaging or vibrating. The massage members may be controlled to operate at one or more speeds.

In another exemplary embodiment, the car seat member 101 includes speakers 112 integrated into the bottom region 109 of the car seat frame 102. The speakers may be any suitable speakers. In a preferred embodiment, the speakers are Bluetooth speakers. The speakers may play lullabies to soothe the baby/toddler/child occupant.

The stroller frame member may be made of any material. In a preferred embodiment, the stroller frame member is made of metal. The stroller frame member is shaped and sized to attach to car seat member 101.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A temperature controlled car seat stroller apparatus comprising:
a car seat comprising a handle; a car seat frame including an interior cushion coupled thereto and having one or more latching mechanisms; a first cooling and heating member integrated into a back rest region of the interior cushion; and a second cooling and heating member integrated into a rear seat region of the interior cushion; wherein the car seat frame is configured to couple to an interior seat of a vehicle and to a stroller frame; and
a stroller frame comprising one or more mating latching mechanisms for attachably coupling to the one or more latching mechanisms of the car seat frame, a handle and a plurality of wheels attached to the bottom of the stroller frame, wherein the stroller frame is configured to receive the car seat for attachment for operation as a stroller.

2. The apparatus of claim 1, wherein the car seat further comprises a first massage member integrated into the back rest region of the interior cushion and a second massage member integrated into the rear seat region of the interior cushion.

3. The apparatus of claim 1, wherein the car seat further comprises one or more speakers integrated into a bottom region of the car sear frame.

4. The apparatus of claim 1, wherein the first and second cooling and heating members are controllable by a remote control.

5. The apparatus of claim 1, wherein the first and second cooling and heating members are controllable by a smart phone.

6. The apparatus of claim 2, wherein the first and second massage members are controllable by a remote control.

7. The apparatus of claim 2, wherein the first and second massage members are controllable by a smart phone.

8. The apparatus of claim 1, wherein the one or more speakers are Bluetooth speakers.

9. The apparatus of claim 1, wherein the first and second cooling and heating members are operable in one or more user-controlled operating settings.

10. The apparatus of claim 2, wherein the first and second massage members are operable in one or more user-controlled operating settings.

11. A temperature controlled configurable car seat apparatus comprising:
a car seat comprising a handle, a car seat frame including an interior cushion coupled thereto, a first cooling and heating member integrated into a back rest region of the interior cushion, a second cooling and heating member integrated into a rear seat region of the interior cushion, a first massage member integrated into the back rest region of the interior cushion and a second massage member integrated into the rear seat region of the interior cushion, and one or more speakers integrated into a bottom region of the car seat frame, wherein the first and second cooling and heating members and the first and second massage members are each operable in one or more operating settings.

12. The apparatus of claim 11, wherein the car seat frame further includes one or more latching mechanisms for attachably coupling to a stroller frame.

13. The apparatus of claim 11, wherein the one or more speakers are Bluetooth speakers.

14. The apparatus of claim 11, wherein the operating settings of the first and second cooling and heating members are controllable by a remote control.

15. The apparatus of claim 11, wherein the operating settings of the first and second cooling and heating members are controllable by a smart phone.

16. The apparatus of claim 11, wherein the operating settings of the first and second massage members are controllable by a remote control.

17. The apparatus of claim 11, wherein the operating settings of the first and second massage members are controllable by a smart phone.
